(19) United States
(12) Patent Application Publication
(10) Pub. No.: US 2020/0271875 A1
(43) Pub. Date: Aug. 27, 2020

(54) ASSEMBLY AND PACKAGING METHOD AND SYSTEM FOR OPTICAL COMPONENTS

(71) Applicant: OTX Ltd., Or Akiva (IL)

(72) Inventor: Eli BENOLIEL, Or Akiva (IL)

(73) Assignee: OTX Ltd., Or Akiva (IL)

(21) Appl. No.: 16/281,110

(22) Filed: Feb. 21, 2019

(51) Int. Cl. G02B 6/42

(52) U.S. Cl. CPC G02B 6/4226; G02B 6/4206

(57) ABSTRACT

Optical apparatus comprises: a wafer having an optical sub-assembly, and at least one groove, the groove being empty of any optical fiber and being for subsequent placement of a single mode optical fiber; at least one optical component fixed on the optical sub-assembly in a direction being optically aligned with the empty groove; such that as said subsequent placement is carried out, said single mode optical fiber is aligned with said optical component to the extent needed for single mode operation.

### FIELD AND BACKGROUND OF THE INVENTION

The present invention relates to an assembly or packaging method and system for optical components and, more particularly, but not exclusively to semiconductor edge lasers where accurate alignment is required.

The accuracy with which component placing is required in the field of edge semiconductor lasers may for example be 1 micron.

Short laser wavelengths are required for communications, and shorter wavelength lasers can provide greater bandwidth.

Known techniques for constructing the laser components place the components on the PCB, but have to use expensive specialist machines for very accurate placing. The tools are expensive. The general technique that is used is to place the laser on the PCB, turn it on, find a maximum in the laser beam and then accurately place an optical fiber at the beam maximum.

The present embodiments seek to address the above issue and provide a simpler alternative for the placing of the fiber at a deviation of 1 micron or less from alignment with the optical component. A method for placing the fiber when the laser diode and groove are in alignment is discussed in U.S. patent application Ser. No. 13/807,938 to the present applicants.

### SUMMARY OF THE INVENTION

In the present apparatus, a wafer is provided with grooves and a location for placing the optical component, for example a laser. The optical component is fixed on the wafer in a direction in which it has been aligned along a respective groove, for example using magnification techniques. Thus the optical component is fixed in alignment with an empty groove, so that the optical fiber, added later, need simply be aligned along the groove.

According to one aspect of the present invention there is provided optical apparatus comprising:

a wafer having an optical sub-assembly;

the wafer having at least one groove, the groove being empty of any optical fiber and being for subsequent placement of a single mode optical fiber; and

at least one optical component fixed on the optical sub-assembly in a direction being optically aligned with the empty groove to an accuracy of at least one micron; such that as the subsequent placement is carried out, the single mode optical fiber is aligned with the optical component to the accuracy of at least one micron.

In an embodiment, the groove is a v-shaped groove.

In an embodiment, the groove comprises an apex for accurate alignment of the optical component.

In an embodiment, the optical component is a laser diode or a bank of laser diodes with a predetermined separation between each laser diode, and the at least one groove is a sequence of equally spaced grooves having the predetermined separation between each groove.

In an embodiment, the optical component has a wavelength which is at or higher than 1310 nm.

In an embodiment, the optical component is a photo-detector.

In an embodiment, the at least one optical component is a laser diode and a photo detector, or a bank of laser diodes and photodetectors, or a bank of laser diodes and a bank of photodetectors.

According to a second aspect of the present invention, there is provided a wafer comprising:

a micro-optical sub-assembly;

at least one groove; and

an optical component, the optical component being fixed on the micro-optical sub-assembly in optical alignment with the groove and held in the alignment by glue, the groove being empty and provided for subsequent addition of a single mode optical fiber to be aligned with the optical component by pressing into the groove.

According to a third aspect of the present invention there is provided apparatus comprising:

an alignment lens having lens grooves;

an imaging device connected to the alignment lens;

a positioning device connected to the imaging device to position components for alignment using the lens grooves;

a wafer comprising wafer grooves and held in a first preset alignment by the positioning device;

a bank of optical components held by the positioning device and held in a second preset alignment by the positioning device;

fixing means for fixing the bank of optical components to the wafer when the wafer is in the first preset alignment and the bank is in the second preset alignment.

In an embodiment, the first preset alignment comprises the wafer grooves being aligned with the lens grooves, and the second preset alignment comprises the optical components being aligned with the lens grooves.

In an embodiment, the imaging device comprises magnification to provide a predetermined accuracy level for the first and second alignments.

In an embodiment, the fixing means comprises a layer of glue.

In an embodiment, the lens is a flat optical lens and the lens grooves comprise parallel lines inscribed on the lens.

Unless otherwise defined, all technical and scientific terms used herein have the same meaning as commonly understood by one of ordinary skill in the art to which this invention belongs. The materials, methods, and examples provided herein are illustrative only and not intended to be limiting.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Implementation of the method and/or system of embodiments of the invention can involve performing or completing selected tasks manually, automatically, or a combination thereof.

Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified schematic diagram illustrating a micro-transmission optical sub-assembly (μTOSA) according to the present embodiments;

FIG. 2 shows a side view of the device of FIG. 1;

FIG. 3 is a side view of the photo-detector assembly of the device of FIG. 1;

FIG. 4A is a simplified diagram illustrating an alignment groove according to the present embodiments and shows an optical fiber placed over the groove and inaccurately aligned;

FIG. 4B is a simplified diagram showing how the optical fiber of FIG. 4A has fallen to the apex of the groove, thus being accurately aligned;

FIG. 5 is a simplified diagram showing a variation of the device of FIG. 1 in which the laser diode is provided but the photo-detector is omitted;

FIG. 6 is a simplified diagram illustrating micro-receiving optical sub-assembly (μROSA) according to the present embodiments;

FIG. 7 is a side view of the embodiment of FIG. 6;

FIG. 8 is a simplified diagram illustrating a transmission optical sub-assembly (TOSA) according to an embodiment of the present invention incorporating the μTOSA of FIG. 1 in a PCB;

FIG. 9 is a simplified diagram showing a side view of the packaged TOSA of FIG. 8;

FIG. 10 is a simplified diagram illustrating a receiver optical sub-assembly (ROSA) according to an embodiment of the present invention incorporating the μROSA of FIG. 6 in a PCB;

FIG. 11 is a simplified diagram illustrating a side view of the packaged ROSA of FIG. 10;

FIG. 12 is a simplified flow chart illustrating an alignment procedure for an optical fiber according to embodiments of the present invention; and

FIG. 13 is a simplified schematic diagram illustrating apparatus according to the present embodiments having an alignment lens 122 with lens grooves.

### DESCRIPTION OF THE PREFERRED EMBODIMENTS

The present embodiments comprise providing a laser diode, photo-detector or other optical component, pre-aligned with a groove. Then the optical fiber is placed in the groove.

In the present apparatus, an optical fiber is provided that is aligned with an optical component in a micro-optical sub-assembly. A micro-sub-assembly has a groove, and the optical component is fixed onto the micro-sub-assembly in alignment with the groove. That is to say optical techniques may be used to find an alignment and then the optical component is fixed to the wafer in that alignment. Optical techniques may include magnification, and the aligned optical component is fixed in the alignment thus found, so that the optical component is pre-aligned with the groove.

An optical fiber is then placed along the groove and is in alignment with the optical component. In this way a placement tool with an accuracy of 50 microns can be used to place an optical fiber with an alignment accuracy of one micron.

The groove may be a v-shaped groove having an apex and the fiber falls into the apex, aligning itself with the optical component.

The required alignment accuracy may be 1 micron or less. The prior art provides a tool that precisely places the fiber to 1 micron accuracy. The present embodiments may use a placement tool with an accuracy of 50 microns since it merely needs to find the groove and then the groove guides the fiber to the necessary accuracy of 1 micron.

In embodiments, the alignment may be carried out between pre-manufactured laser bars, say in the range of 1310 nm and higher, and a semiconductor fab manufactured wafer having grooves. The wafer is thus already grooved and otherwise processed at this point, and the diced finished part allows for simple automatic alignment of a single mode (monomode) optical fiber with the laser or any other optical component in a micro-optical sub-assembly.

Although accurate placement of the laser and alignment with the groove are still required, this can be provided using conventional equipment since optical alignment may readily benefit from magnification. The obviation of the need for accurate placement of the fiber provides a considerable cost saving in terms of the tools required.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

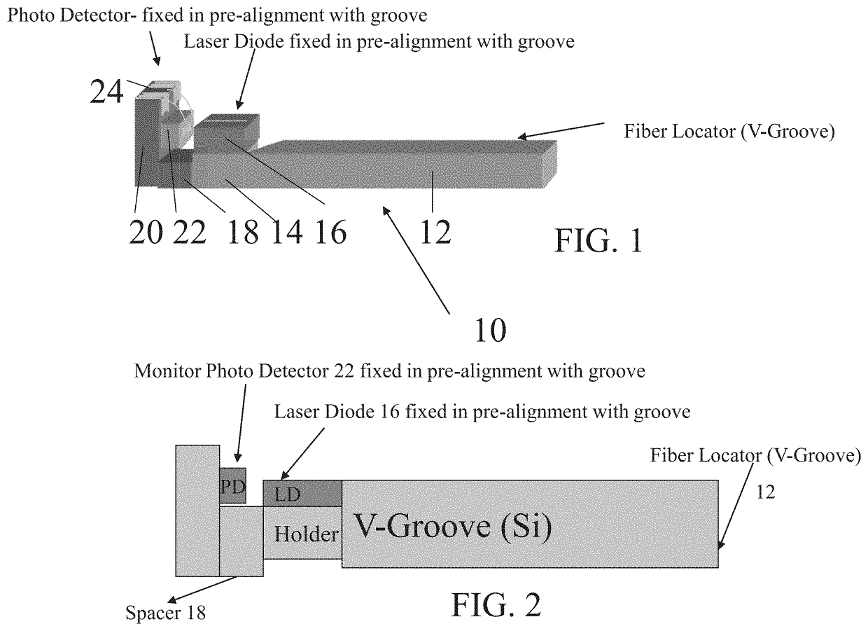

Reference is now made to FIG. 1 which is an isometric schematically illustrating a micro-transmission optical sub-assembly (μTOSA). The sub-assembly 10 comprises a silicon fiber locator element 12 in which is etched a v-shaped groove. A holder, 14, abuts the locator element. Mounted on the holder 14 is laser diode 16. A space element 18 provides and defines a precise separation space behind laser diode 16, and a further holder 20 abuts onto the space element 18. On the front of the further holder 20 a monitoring photo-detector 22 is mounted. Electrical contacts 24 are provided on the further holder 20. Wire bonding 26 connects the optical components to contacts 24.

The holder 14 plays a part in distributing of heat from the laser and may be mounted with a heat sink, as discussed in greater detail below. Holes may be inserted in the holder for connection to the heat sink.

FIG. 2 is a side view along the μTOSA 10 of FIG. 1. The parts are the same as those in FIG. 1 and are given the same reference numerals.

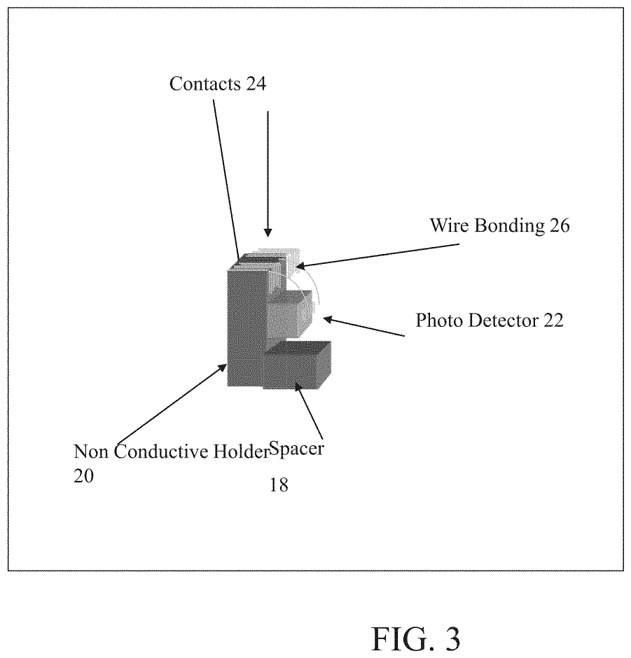

FIG. 3 shows in greater detail the construction of the photo-detector sub-assembly of FIG. 1. Again, the parts are the same as those in FIG. 1 and are given the same reference numerals.

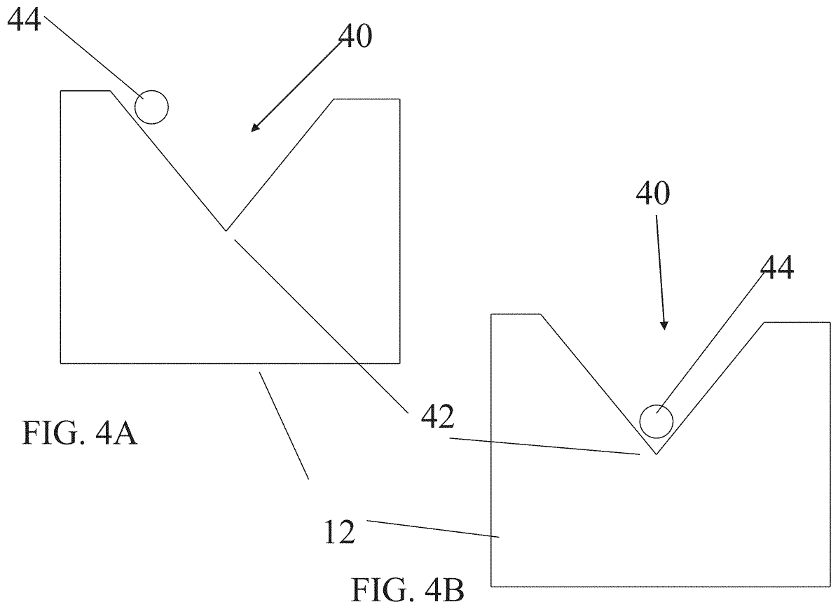

Reference is now made to FIG. 4A which is a simplified transverse cross section of the locator element 12, showing v-shaped groove 40 etched therein. The groove 40 has apex 42. Optical fiber 44 is placed on the groove by an inaccurate placing tool.

FIG. 4B shows how optical fiber 44 is brought into accurate alignment by falling into apex 42 of the groove 40.

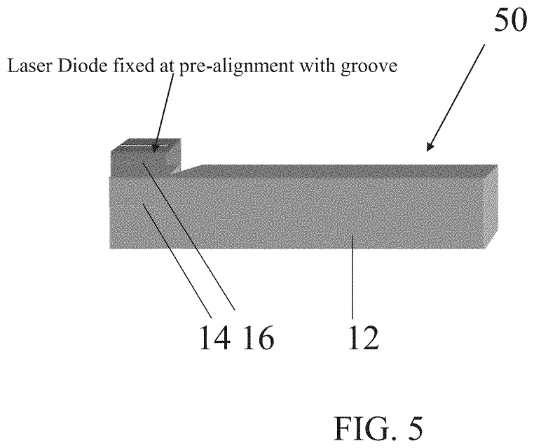

Reference is now made to FIG. 5 which shows a further embodiment of a μTOSA. The optical diode assembly of FIG. 3 may be dispensed with to provide a three piece unit 50 comprising laser 16, groove locator 12 and laser holder 14.

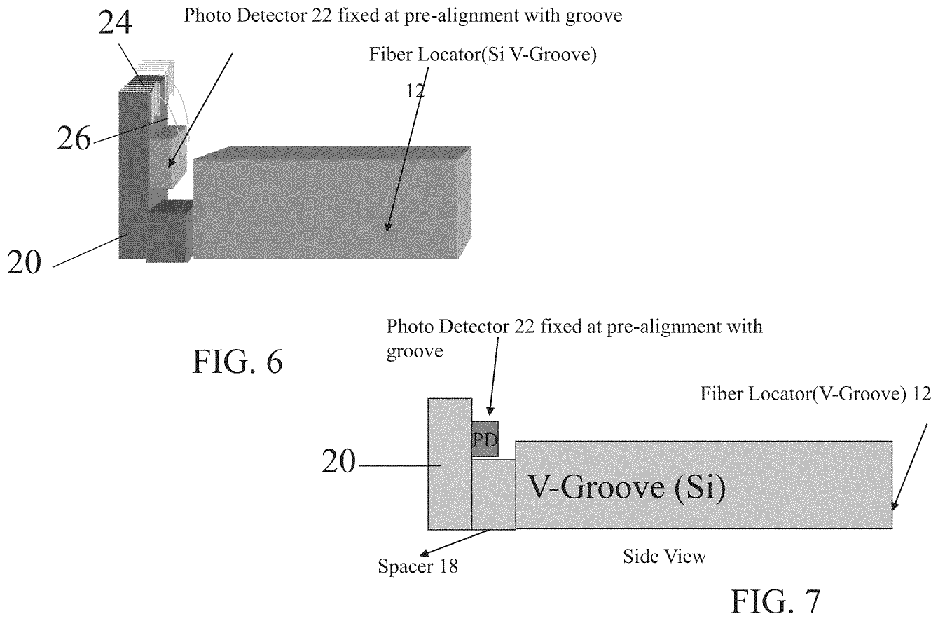

Reference is now made to FIG. 6, which is a simplified diagram illustrating a micro-receiving optical sub-assembly (μROSA). Parts that are the same as shown in FIG.

1 are given the same reference numerals and are not described again except as necessary to describe the present embodiment. A receiving optical sub-assembly simply detects incoming laser light and thus has a photo-detector 22 in place of the laser diode. The photo-detector 22 is aligned with the groove which extends along holder 12 and is spaced therefrom due to spacer 18, but otherwise the construction is as described above.

FIG. 7 is a longitudinal side view of the μROSA of FIG. 6. The detail of the photodetector sub-assembly is as shown in FIG. 3.

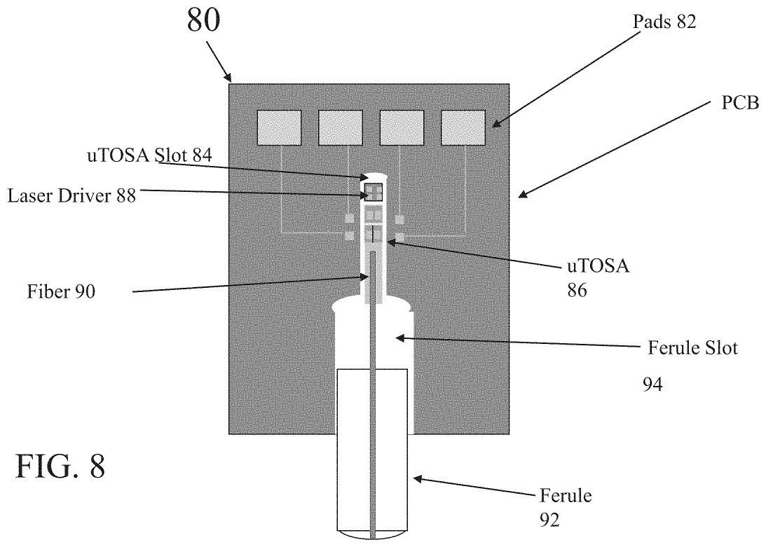

Reference is now made to FIG. 8, which is a simplified diagram of a transmission optical sub-assembly onto which the μTOSA of FIGS. 1-4B, or of FIG. 5 is inserted. PCB 80 has connection pads 82 for electrical connections to external equipment. A μTOSA slot 84 accepts μTOSA 86 and laser driver 88. Fiber 90 extends from ferule 92 and is aligned along the groove so that it lines up with the laser inside the μTOSA 86. Ferule 92 is placed in ferule slot 94 in the PCB 80.

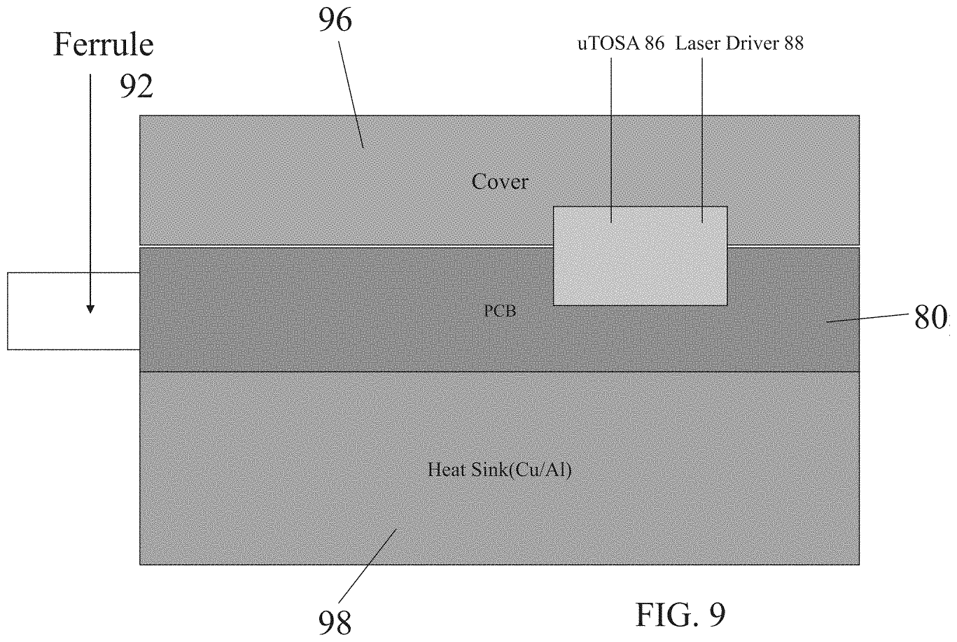

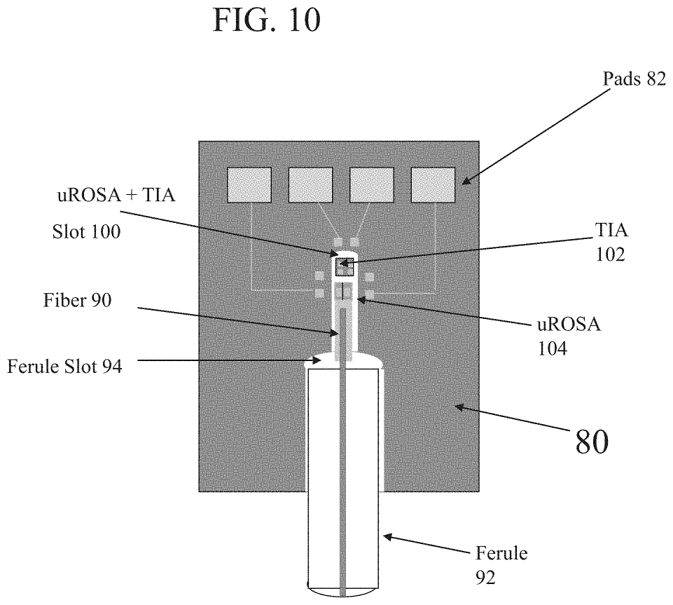

Reference is now made to FIG. 9, which is a simplified diagram illustrating the packaging of the optical sub-assembly of FIG. 8. Parts that are the same are given the same reference numerals. PCB 800 with μTOSA 86 and laser driver 88 is covered and sealed with cover 96. Heat sink 98, typically aluminium or copper, is placed under PCB 80 to conduct heat away from the laser diode and μTOSA. Holes may be drilled in the PCB and the silicon holders and may optionally be filled with metal to improve heat conduction.

Reference is now made to FIG. 10, which shows the ROSA PCB layout for the μROSA. Parts that are the same as in FIG. 8 are given the same reference numerals and are not described again except as necessary for an understanding of the present embodiment. PCB 80 includes slot 100 into which is inserted TIA optical receiver 102 and μROSA 104. Fiber 90 extending from ferule 92 is aligned with the v-shaped groove as before.

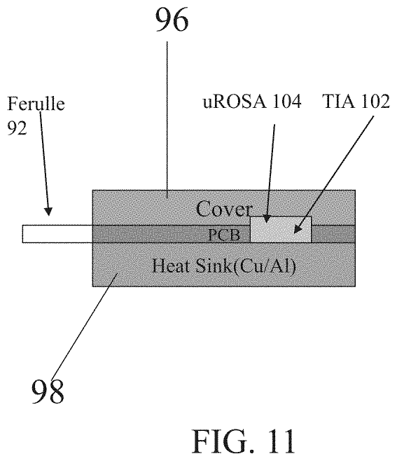

FIG. 11 illustrates the cross-section of the packaged PCB of FIG. 10. Parts that are the same as in previous figures are given the same reference numerals and are not described again except as needed for an understanding of the present embodiments. The figure is in fact identical to that of FIG. 9 except that the TIA optical detector and the μROSA replace the laser driver and μTOSA.

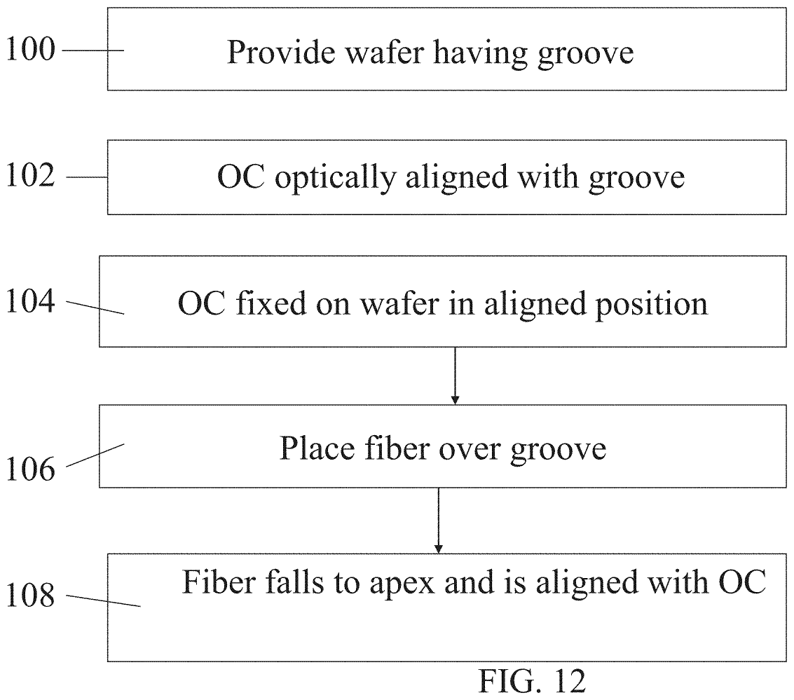

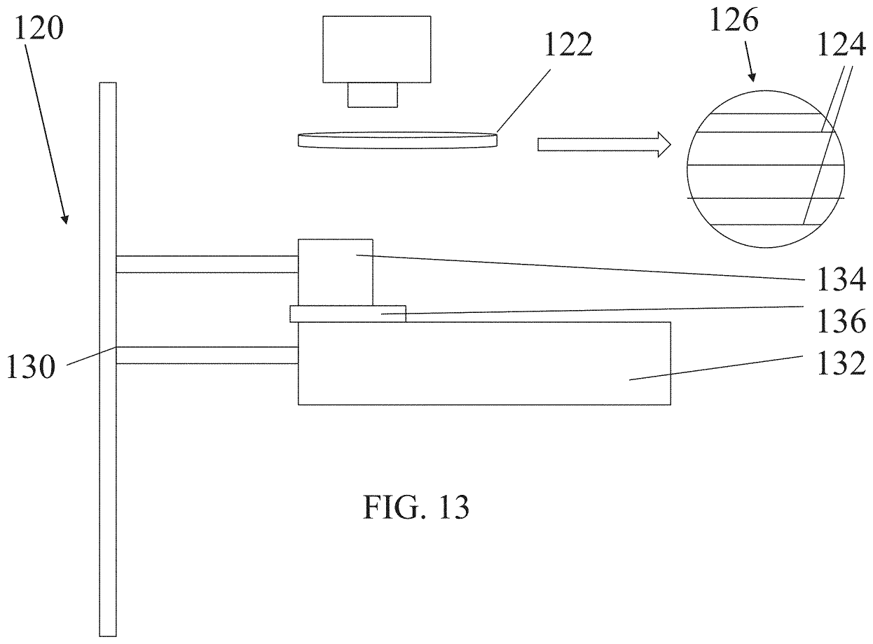

Reference is now made to FIG. 12, which is a simplified diagram illustrating a method of aligning an optical fiber with an optical component in a micro-optical sub-assembly. There is initially provided a wafer having a groove 100. A micro-sub-assembly is provided with an optical component which is optically aligned with the groove—102. That is optical techniques may be used including magnification, and including the technique discussed below in respect of FIG. 13, and once aligned, the optical component is then fixed 104 to the micro-sub-assembly, thus to provide a micro-sub-assembly with an optical component aligned with the groove. At this point no optical fiber is present in the groove. The optical fiber is then placed—106—over the groove and allowed to fall—108—to the apex, thereby aligning the optical fiber with the optical component.

Reference is now made to FIG. 13, which shows apparatus 120 having an alignment lens 122 with lens grooves. The lens grooves 124 are shown in insert 126 where lens 122 is shown from above. An imaging device 128 looks through the alignment lens at components for alignment.

A positioning device 130 is connected to the imaging device to position components for alignment. The alignment process uses the lens grooves to align with features on the components. Typically, misalignment generates error signals to the alignment device which is thus controlled by a processor and imaging software based on the imaging device view of the component through the lens.

Wafer 132 has wafer grooves as shown in earlier figures, and the wafer is held in a first preset alignment by the positioning device 130.

A bank 134 of optical components is also held by the positioning device and is placed in a second preset alignment. Again the lens grooves are used to align the bank of optical components.

Fixing means 136 fixes the bank of optical components to the wafer so that the wafer is fixed in the first preset alignment and the bank is fixed on the wafer in the second preset alignment. The fixing means may be any known way in the art for fixing components to a wafer, including heat-activated glue.

In greater detail, a wafer is scribed with a series of grooves, of the kind discussed above for the fibers, at typically fixed distances apart, the distances being chosen to be similar to the positions of single lasers in a bar of manufactured lasers. The bar of lasers may be made with tolerances of +−0.5 microns.

The wafer is covered with heat activated glue.

The laser bar is positioned on top of the wafer in an assembly machine. The machine may first position the wafer in a fixed and defined position through alignment with light rays going through a level flat optic lens that has inscribed parallel lines, referred to herein as lens grooves, under supervision of a magnifying camera. The same process of alignment is carried out with the laser bar so that the bar and the scribed wafer are aligned to within tolerances of for example +−1 microns.

The above process using a flat optic lens with lens grooves and a camera is included in the term “optically aligned” as referred to herein.

After heating to activate the glue the lasers are fixed in the alignment orientation along with the grooved wafer to provide a grooved wafer with optical components fixed in alignment with the grooves, but having no fibers in the grooves. The groove can be subsequently used to align a single mode optical cable simply by dropping the fiber into the groove, thus requiring nothing more than a simple automatic assembly line.

The groove may be a v-shaped groove, and alignment may involve pressing the fiber firmly into the apex. The groove may be cut into a length of silicon, and the optical component may be a laser diode or a photo-detector.

The laser diode may lase at a wavelength which is at or below 365 nm.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Optical apparatus comprising:
a wafer having an optical sub-assembly;
the wafer having at least one groove, the groove being empty of any optical fiber and being for subsequent placement of a single mode optical fiber;
at least one optical component fixed on the optical sub-assembly in a direction being optically aligned with the empty groove to an accuracy of at least one micron; such that as said subsequent placement is carried out, said single mode optical fiber is aligned with said optical component to said accuracy of at least one micron.

2. The optical apparatus of claim 1, wherein said groove is a v-shaped groove.

3. The optical apparatus of claim 2, wherein said groove comprises an apex for accurate alignment of said optical component.

4. The optical apparatus of claim 1, wherein said optical component is a laser diode or a bank of laser diodes with a predetermined separation between each laser diode, and said at least one groove is a sequence of equally spaced grooves having said predetermined separation between each groove.

5. The optical apparatus of claim 4, wherein said optical component has a wavelength which is at or higher than 1310nm.

6. The optical apparatus of claim 1, wherein said optical component is a photo-detector.

7. The optical apparatus of claim 1, wherein said at least one optical component is a laser diode and a photo detector, or a bank of laser diodes and photodetectors, or a bank of laser diodes and a bank of photodetectors.

8. A wafer comprising:
a micro-optical sub-assembly;
at least one groove;
an optical component, the optical component being fixed on said micro-optical sub-assembly in optical alignment with said groove and held in said alignment by glue, the groove being empty and provided for subsequent addition of a single mode optical fiber to be aligned with said optical component by pressing into said groove.

9. The wafer of claim 8, wherein said groove is a v-shaped groove.

10. The wafer of claim 9, wherein said groove comprises an apex for accurate alignment of said optical component.

11. The wafer of claim 8, wherein said optical component is a laser diode or a bank of laser diodes with a predetermined separation between each laser diode, and said at least one groove is a sequence of equally spaced grooves having said predetermined separation between each groove.

12. The wafer of claim 11, wherein said optical component has a wavelength which is at or higher than 1310 nm.

13. The wafer of claim 8, wherein said optical component is a photo-detector.

14. The wafer of claim 8, wherein said at least one optical component is a laser diode and a photo detector, or a bank of laser diodes and photodetectors, or a bank of laser diodes and a bank of photodetectors.

15. Apparatus comprising:
an alignment lens having lens grooves;
an imaging device connected to said alignment lens;
a positioning device connected to said imaging device to position components for alignment using said lens grooves;
a wafer comprising wafer grooves and held in a first preset alignment by said positioning device;
a bank of optical components held by said positioning device and held in a second preset alignment by said positioning device;
fixing means for fixing said bank of optical components to said wafer when said wafer is in said first preset alignment and said bank is in said second preset alignment.

16. The apparatus of claim 15, wherein said first preset alignment comprises said wafer grooves being aligned with said lens grooves, and said second preset alignment comprises said optical components being aligned with said lens grooves.

17. The apparatus of claim 15, wherein said imaging device comprises magnification to provide a predetermined accuracy level for said first and second alignments.

18. The apparatus of claim 15, wherein said fixing means comprises a layer of glue.

19. The apparatus of claim 15, wherein said lens is a flat optical lens and said lens grooves comprise parallel lines inscribed on said lens.
